(19) United States
(12) Patent Application Publication
(10) Pub. No.: US 2022/0384875 A1
(43) Pub. Date: Dec. 1, 2022

(54) BATTERY MODULE AND BATTERY PACK INCLUDING THE SAME

(71) Applicant: LG ENERGY SOLUTION, LTD., Seoul (KR)

(72) Inventors: Jeonghoon PARK, Daejeon (KR); Yongjoon CHOI, Daejeon (KR); Boseon KIM, Daejeon (KR); Seungwon HAN, Daejeon (KR)

(21) Appl. No.: 17/773,826

(22) PCT Filed: Jul. 19, 2021
(86) PCT No.: PCT/KR2021/009279

§ 371 Date: May 2, 2022

(30) Foreign Application Priority Data
Aug. 24, 2020 (KR) 10-2020-0106089

(51) Int. Cl. H01M 10/655; H01M 10/613; H01M 10/647; H01M 10/653; H01M 10/625

(52) U.S. Cl. CPC H01M 10/655; H01M 10/613; H01M 10/647; H01M 10/653; H01M 10/625

(57) ABSTRACT

A battery module including: a battery cell stack including a plurality of battery cells, a housing for the battery cell stack, and a heat conductive pad located between the upper part of the housing and the battery cell stack. The heat conductive pad has a recessed pattern corresponding to a first end part of the plurality of battery cells on a surface facing the battery cell stack.

### CROSS-REFERENCE TO RELATED APPLICATIONS

This application is a US national phase of international Application No. PCT/KR2021/009279 filed on Jul. 19, 2021, and claims the benefit of Korean Patent Application No. 10-2020-0106089 filed on Aug. 24, 2020 with the Korean Intellectual Property Office, the disclosures of which are incorporated herein by reference in their entirety.

### TECHNICAL FIELD

The present disclosure relates to a battery module and a battery pack including the same, and more particularly, to a battery module with improved cooling performance, and a battery pack including the same.

### BACKGROUND

With advances in technological development and increasing demand for a mobile device, demand for a secondary battery as an energy source is also rapidly increasing. Accordingly, research into developing a battery capable of meeting a variety of needs has emerged.

A secondary battery has attracted considerable attention as an energy source for power-driven devices, such as an electric bicycle, an electric vehicle, and a hybrid electric vehicle, as well as an energy source for mobile devices, such as a mobile phone, a digital camera, and a laptop computer.

Generally, lithium secondary batteries may be classified based on the shape of the exterior material as a can type secondary battery, in which the electrode assembly is built in a metal can, and a pouch-type secondary battery, in which the electrode assembly is built in a pouch of an aluminum laminate sheet.

Small-sized mobile devices use one to three battery cells for each device, whereas middle or large-sized devices such as vehicles require high power and large capacity. Therefore, a middle or large-sized battery module having a plurality of battery cells electrically connected to one another is used. In such a battery module, a large number of battery cells are connected to each other in series or parallel to form a cell stack, thereby improving capacity and output. In addition, one or more battery modules can be mounted together with various control and protection systems such as a battery management system (BMS) and a cooling system to form a battery pack.

Since the battery cells of these middle or large-sized battery modules are composed of chargeable/dischargeable secondary batteries, such a high-output and large-capacity secondary battery generates a large amount of heat during a charging and discharging process. In particular, it is difficult to effectively reduce the temperature of all the battery cells because the laminate sheet of the pouch-shaped battery widely used in the battery pack is surface-coated with a polymer material having low heat conductivity.

When heat generated during the charging and discharging process is not effectively eliminated, heat accumulation may occur, which may accelerate deterioration of the battery cells, and under certain circumstances, the battery module may catch fire or explode. Therefore, a cooling system for cooling the battery cells in a high-output, large-capacity battery module and/or battery pack may be important.

### DETAILED DESCRIPTION

It is an objective of the present disclosure to provide a battery module with improved cooling performance, and a battery pack including the same.

However, the technical problem to be solved by embodiments of the present disclosure is not limited to the above-described problems, and can be variously expanded within the scope of the technical idea included in the present disclosure.

According to one exemplary embodiment of the present disclosure, there is provided a battery module comprising: a battery cell stack formed by stacking a plurality of battery cells, a housing for the battery cell stack, and a heat conductive pad located between the upper part of the housing and the battery cell stack, wherein the heat conductive pad has a recessed pattern corresponding to a first end part of the battery cells on a surface facing the battery cell stack.

The first end part of the battery cells may have a double-sided folded shape.

The battery cell includes a cell case and an electrode assembly housed in the cell case, and the double-sided folded shape may be a shape of the double-folded sealing part formed by folding the sealing part of the cell case at least twice.

The battery further includes an electrode lead that protrudes from at least one of both side surfaces of the battery cells disposed along a direction perpendicular to the first end part of the battery cell, wherein the battery cell may have a rectangular shape in the direction in which the electrode lead protrudes.

The recessed pattern of the heat conductive pad may include a plurality of recessed parts corresponding to the double-folded sealing part of each of the plurality of battery cells.

The first end part of the battery cell may have two mutually different inclined surfaces, the depressed part may be formed to correspond to one of the two inclined surfaces, and the double-folded sealing part may be in close contact with the recessed part.

The inclined surface of the double-folded sealing part and the inclined surface of the heat conductive pad on which the recessed part may be formed are in contact with each other.

The heat conductive pad has a first surface facing the upper part of the housing, and a second surface facing the battery cell stack, and the first surface and the second surface may have a mutually asymmetric structure.

The first surface of the heat conductive pad may have a surface parallel to the upper part of the housing.

The depressed pattern may have a sawtooth shape.

The battery module may further include a heat conductive resin layer located between the lower part of the housing and the battery cell stack.

The housing includes a frame member including a bottom part and two side surface parts facing each other, and an upper plate covering an open upper part of the frame member, and the heat conductive resin layer may be located between the bottom part of the frame member and the battery cell stack.

The bottom part and the side surface parts included in the frame member may be integrally formed.

The battery may further include a heat conductive resin member located between the recessed pattern of the heat conductive pad and the first end part of the battery cell.

According to another exemplary embodiment of the present disclosure, there is provided a battery pack comprising the above-mentioned battery module.

According to various embodiments of the present disclosure, an additional heat transfer member is formed between the upper part of the housing and the battery cell stack, thereby improving the heat conduction performance for discharging heat generated from the battery cells and improving the cooling performance of the battery module and the battery pack.

### BRIEF DESCRIPTION OF THE DRAWINGS

FIG. 1 is an exploded perspective view of a battery module according to one exemplary embodiment of the present disclosure;

FIG. 2 is a perspective view of the battery module of FIG. 1 when all the components are coupled;

FIG. 3 is a perspective view of a battery cell included in the battery cell stack of FIG. 1;

FIG. 4 is a cross-sectional view along the yz plane of FIG. 2;

FIG. 5 is an enlarged perspective view of section A of FIG. 4;

FIG. 6 is an illustration of a heat conductive pad structure according to the present embodiment;

FIG. 7 is an illustration of a battery module equipped with the heat conductive pad of FIG. 6;

FIG. 8 is a graphical representation of the temperature change over time of a center battery cell;

FIG. 9 is a graphical representation of the temperature change over time of an edge cell;

FIGS. 10 and 11 are illustrations of a battery module according to another exemplary embodiment of the present disclosure; and

FIG. 12 is an illustration of a modified method of filling the heat conductive resin in the battery module of FIG. 10.

### DETAILED DESCRIPTION

Hereinafter, various embodiments of the present disclosure will be described in detail with reference to the accompanying drawings so that those skilled in the art can easily implement them.

The present disclosure can be modified in various different ways, and is not limited to the embodiments set forth herein.

Portions that are irrelevant to the description will be omitted to clearly describe the present disclosure, and like reference numerals designate like elements throughout the specification.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are shown to be exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the specification, when a portion is referred to as “including” a certain component, it means that the portion can further include other components, without excluding the other components, unless otherwise stated.

Further, throughout the specification, when referred to as “planar”, it means when a target portion is viewed from the upper side, and when referred to as “cross-sectional”, it means when a target portion is viewed from the side of a cross section cut vertically.

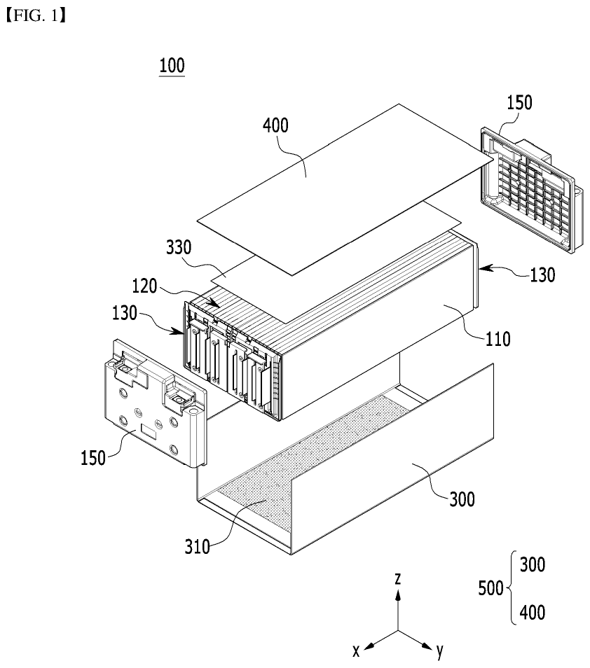

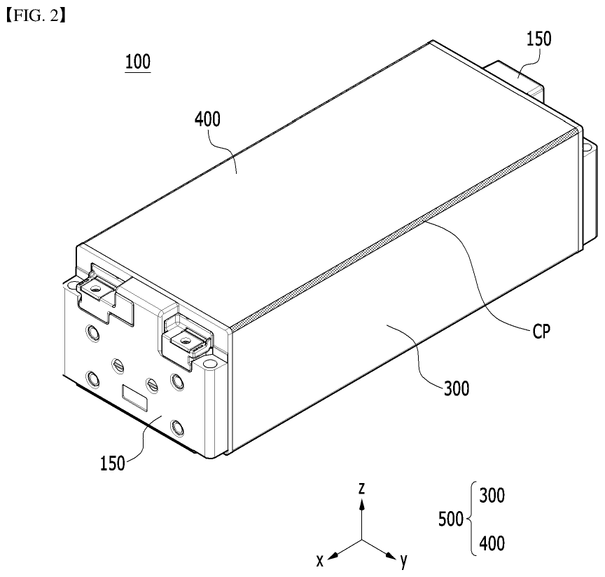

FIG. 1 is an exploded perspective view of a battery module according to one exemplary embodiment of the present disclosure. FIG. 2 is a perspective view of the battery module of FIG. 1 when all the components are coupled. FIG. 3 is a perspective view of one battery cell included in the battery cell stack of FIG. 1.

As illustrated in FIGS. 1 and 2, a battery module 100 according to one exemplary embodiment of the present disclosure includes a battery cell stack 120 containing a plurality of battery cells 110, a housing 500 for housing the battery cell stack 120, and end plates 150 for covering the front surface and the rear surface of the housing 500. The housing 500 may include a frame member 300 of which an upper part, a front part and a rear part are open, and an upper plate 400 that covers the upper part of the battery cell stack 120. The frame member 300 may be U-shaped. The battery module 100 further includes bus bar frames 130 located between the battery cell stack 120 and the end plates 150. The end plates 150 may be formed of a metal material such as aluminum. The end plates 150 may include a front surface plate for covering one side of the housing 500 and a back surface plate for covering the other side of the housing 500.

When open, both sides of the frame member 300 are referred to as a first side and a second side, respectively, and the frame member 300 has a plate-shaped structure that is bent so as to continuously wrap the front, lower and rear surfaces adjacent to each other among the remaining outer surfaces excluding surfaces of the battery cell stack 120 corresponding to the first side and the second side. The upper part corresponding to the lower part of the frame member 300 is open. Specifically, the frame member 300 may include a bottom part and two side parts facing each other. In this case, the bottom part and the two side parts may be integrally formed.

The upper plate 400 has a single plate-shaped structure that wraps the remaining upper surface excluding the front, lower and rear surfaces of the battery cell stack 120 which are wrapped by the frame member 300. The frame member 300 and the upper plate 400 can be coupled by welding or the like in a state in which the corresponding corner areas are in contact with each other, thereby forming a structure wrapping the battery cell stack 120. That is, the frame member 300 and the upper plate 400 can have a coupling part CP formed at a corner where they meet by a coupling method such as welding, thereby forming a housing 500.

The battery module 100 according to the present disclosure includes a heat conductive resin layer 310 located between the housing 300 and the battery cell stack 120, and a heat conductive pad 330 located between the upper plate 400 and the battery cell stack 120. The heat conductive pad 330 may be formed of a silicon-based material similar to the heat conductive resin layer 310, and can function as a compression pad.

The battery cell stack 120 includes a plurality of battery cells 110 stacked in one direction, and the plurality of battery cells 110 may be stacked in the Y-axis direction as shown in FIG. 1. The battery cell 110 is preferably a pouch-type battery cell. For example, as illustrated in FIG. 3, the battery cell 110 according to the present embodiment may have a structure in which the two electrode leads 111 and 112 protrude from one end part 114a and the other end part 114b, respectively, of the battery body 113 in opposite directions. The battery cell 110 can be manufactured by joining both end parts 114a and 114b of the cell case 114 and both side surfaces 114c connecting them to form an electrode assembly (not shown) housed in the cell case 114. In other words, the battery cell 110 according to the present embodiment has a total of three sealing parts 114sa, 114sb and 114sc, and the sealing parts 114sa, 114sb and 114sc are sealed by a method such as heat fusion, and the remaining other side portion may be formed of a connection part 115. A space between both end parts 114a and 114b of the battery case 114 is defined as a longitudinal direction of the battery cell 110, and a space between the one side surface 114c and the connection part 115 that connect both end parts 114a and 114b of the battery case 114 is defined as a width direction of the battery cell 110.

The connection part 115 is a region extending along one edge of the battery cell 110, and a protrusion part 110p of the battery cell 110 may be formed at an end part of the connection part 115. The protrusion part 110p may be formed on at least one of both side surfaces of the connection part 115 and may protrude in a direction perpendicular to the direction in which the connection part 115 extends. The protrusion part 110p may be located between one of the sealing parts 114sa and 114sb of both end parts 114a and 114b of the battery case 114, and the connection part 115.

The cell case 114 is generally formed of a laminate structure of a resin layer/metallic thin film layer/resin layer. For example, a surface of the battery case formed of an O (oriented)-nylon layer tends to slide easily in the event of an external impact when a plurality of battery cells are stacked to form a medium or large-sized battery module. Therefore, in order to prevent this sliding and maintain a stable stacked structure of the battery cells, the battery cell stack 120 can be formed by attaching an adhesive member, for example, a sticky adhesive such as a double-sided tape or a chemical adhesive coupled by a chemical reaction upon adhesion, to the surface of the battery case. In the present embodiment, the battery cell stack 120 is stacked in a Y-axis direction and housed in the frame member 300 in a Z-axis direction, and then can be cooled by a heat conductive resin layer described later. As a comparative example thereto the battery cells may be formed as cartridge-shaped components so that fixing between the battery cells is made by assembling the battery housing. In this comparative example, the cooling action may be little or may proceed in a surface direction of the battery cells because of the presence of the cartridge-shaped components, whereby the cooling does not work well in a height direction of the battery module.

Widths of the side surface parts 300b of the U-shaped frame 300 and the upper plate 400 according to the present embodiment may be identical to each other. In other words, a corner portion along an X-axis direction of the upper plate 400 and a corner portion along an X-axis direction of the side surface parts 300b of the frame member 300 can meet each other and be coupled by a method such as welding.

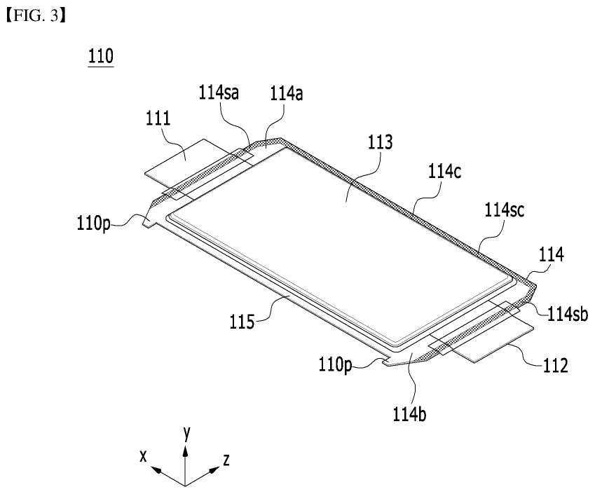

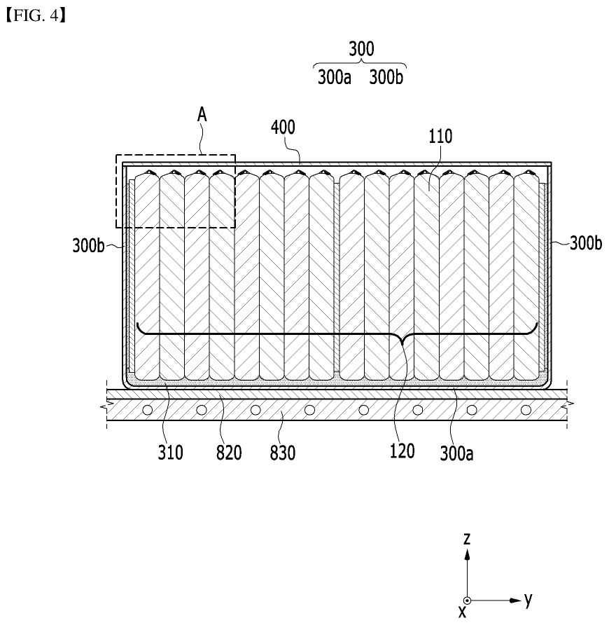

FIG. 4 is a cross-sectional view of the battery module along the yz plane of FIG. 2.

As illustrated in FIGS. 2 and 4, the battery module 100 according to the present embodiment may include a heat transfer mediation layer 820 located under the bottom part 300a of the housing 500. The heat transfer mediation layer 820 may be formed of a heat transferable material that allows the heat transferred to the housing 500 to be transferred to a heat sink 830 described later.

The battery module 100 according to the present embodiment may further include a heat sink 830 located under the heat transfer mediation layer 820. The heat sink 830 includes a refrigerant flow path formed therein, and can discharge heat generated in the battery cell stack 120 to the outside. However, the cooling performance require by the user is limited when only using the heat transfer mediation layer 820 and/or the heat conductive resin layer 310 for the purpose of increasing heat efficiency with the heat sink 830.

It is necessary to lower the maximum temperature due to heat generation of the battery cells in the battery module, and reduce the temperature deviation due to the battery cell position to improve the cooling performance. However, if a cooling device is added, there is a drawback in that the volume of the battery module increases. In order to improve such a problem, according to the present embodiment, a heat conductive pad 330 is formed in an air space between the upper plate 400 and the battery cell stack 120 where the heat sink 830 is not formed, thereby improving the cooling performance while maintaining a compact module structure.

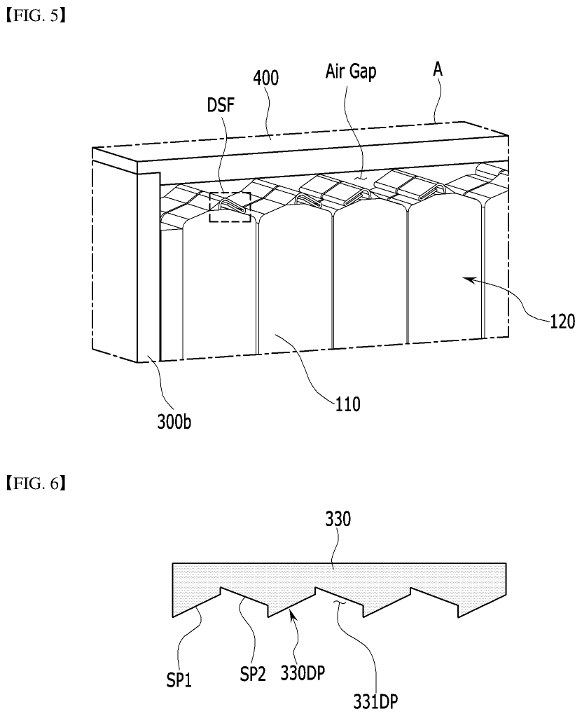

FIG. 5 is an enlarged perspective view of section A of FIG. 4.

According to the comparative example, as shown in FIG. 5, an air gap may exist between the upper plate 400 and the battery cell stack 120. The air gap can deteriorate the heat conduction characteristics, and in order for the heat of the upper end part of the battery cell 110, particularly the part of the battery cell 110 adjacent to the double-sided folded sealing part DSF, to be transferred to the heat sink 830 of FIG. 4 and cooled, it must pass through several layers, and therefore, the cooling efficiency may decrease.

FIG. 6 is an illustration of a heat conductive pad according to the present embodiment. FIG. 7 is an illustration of a battery module equipped with the heat conductive pad of FIG. 6.

As illustrated in FIGS. 6 and 7, the heat conductive pad 330 according to the present embodiment is located between the upper plate 400 corresponding to the upper part of the housing and the battery cell stack 120. The heat conductive pad 330 has a first surface facing the upper part of the housing and a second surface facing the battery cell stack, and the first surface and the second surface have an asymmetric structure with each other. The first surface may have a surface parallel to the upper plate 400 corresponding to the upper part of the housing.

The heat conductive pad 330 has a recessed pattern 330DP formed on a surface facing the battery cell stack 120. The recessed pattern 330DP may have a sawtooth shape. The recessed pattern 330DP has a structure corresponding to the first end part of the battery cell 110, and the first end part of the battery cell 110 may have a double-sided folded shape. The double-sided folded shape is a shape of the double-sided folded sealing part (DSF) formed by folding the sealing part of the cell case at least twice. Specifically, the first end part of the battery cell 110 may be a part 114sc to which both side surfaces 114c of the cell case 114 connecting both end parts 114a and 114b of the cell case 114 are adhered as shown in FIG. 3. In FIG. 3, the electrode leads 111 and 112 may be located at both end parts of the battery cell 110 located along a direction perpendicular to the first end part of the battery cell 110, and the battery cell 110 may have a rectangular structure in which the electrode leads 111 and 112 are formed in a protruding direction.

As illustrated in FIGS. 6 and 7, the recessed pattern 330DP of the heat conductive pad 330 according to the present embodiment includes a plurality of recessed parts 331DP corresponding to the double-sided folded sealing part DSF of each of the plurality of battery cells 110.

The first end part of the battery cell 110 has two mutually different inclined surfaces, and the heat conductive pad 330 also has a first inclined surface SP1 and a second inclined surface SP2 to correspond thereto. The first inclined surface SP1 of the heat conductive pad 330 may be in contact with the first end part of the battery cell 110, and the second inclined surface SP2 of the heat conductive pad 330 may be in contact with the inclined surface of the double-sided folded sealing part DSF. To form such a structure, the double-sided fold sealing part DSF may be in close contact with the recessed part 331DP of the heat conductive pad 330. By realizing such a structure, the contact area between the battery cell stack 120 and the heat conductive pad 330 can be maximized and the cooling performance can be improved.

Due to the double-sided folded sealing part DSF structure, an air gap may be formed between the battery cell 110 and the double-sided folded sealing part DSF. Consequently, a part in which the second inclined surface SP2 of the heat conductive pad 330 and the inclined surface of the double-sided folded sealing part DSF are in contact with each other, can have weak adhesive force, compared to a part in which the first inclined surface SP1 of the heat conductive pad 330 is in contact with the first end of the battery cell 110. Therefore, as shown in FIG. 7, heat moving in the arrow direction passing through the second inclined surface SP2 may be relatively small compared to the heat moving in the arrow direction passing through the first inclined surface SP1.

Specifically, since the double-sided folded sealing part (DSF) folds twice to finish the sealing part, the heat efficiency of the die sealing gap existing therebetween may be supplemented through the heat conductive pad 330.

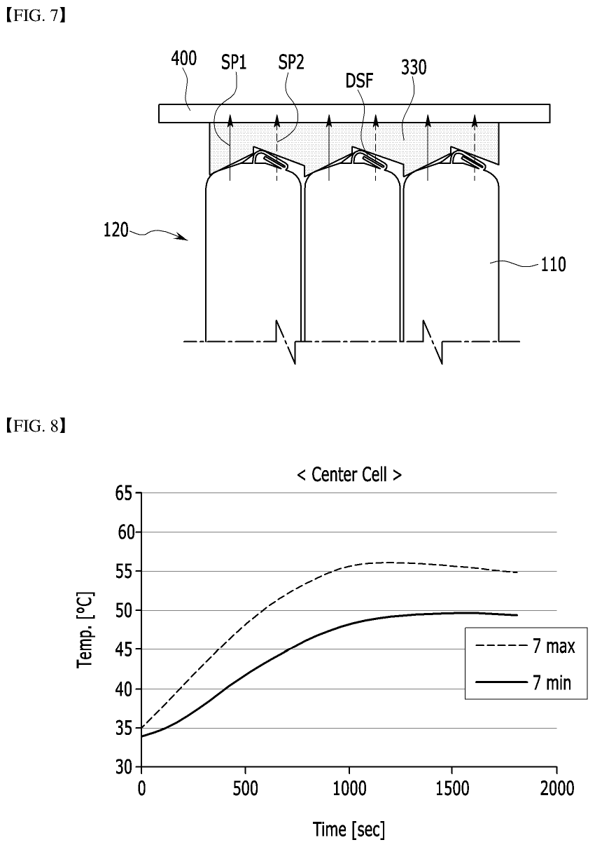

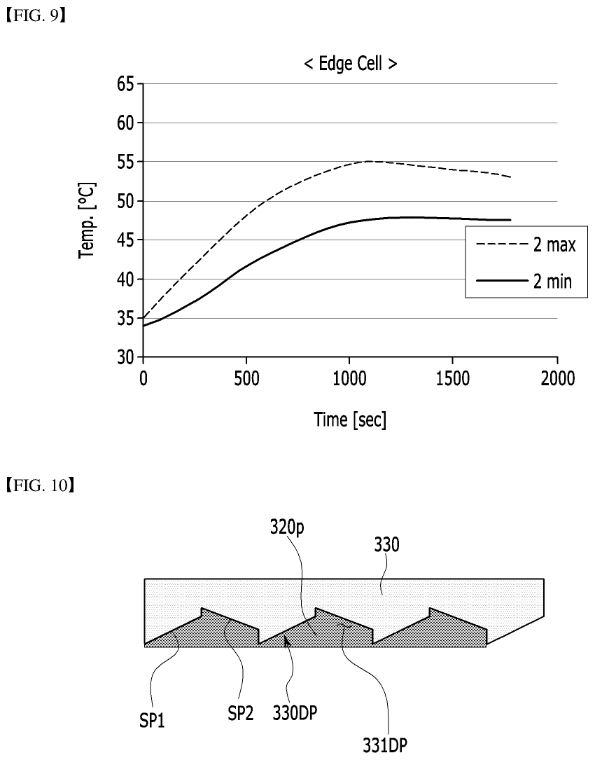

FIG. 8 shows the temperature change over time in the case of a center battery cell. FIG. 9 shows the temperature change over time in the case of an edge cell.

Table 1 below summarizes the results shown in FIGS. 8 and 9 including the maximum values, minimum values, and temperature gap values.

TABLE 1

| | Center Cell | | Edge Cell | | |
|---|---|---|---|---|---|
| | maximum | minimum | maximum | minimum | Tempera- |
| | value | value | value | value | ture Gap |
| Comparative | 58.6 | 50.3 | 56.2 | 48.4 | 10.2 |
| Example | | | | | |
| Example | 56.1 | 48.9 | 55.0 | 47.6 | 8.5 |

As shown in FIG. 8, and illustrated in FIG. 5, in the comparative example, an air gap exists between the upper plate 400 and the battery cell stack 120. In this comparative example, when the battery cell is charged and discharged (under the condition that charging is higher than 1C rate, discharging is lower than 1C rate), the temperature rapidly increases at the initial stage due to the generated heat, and after about 1000 seconds or more, it appears as converging to a constant temperature. As shown in FIG. 9, in the embodiment of the present disclosure, a heat conductive pad 330 exists between the upper plate 400 and the battery cell stack 120. In the embodiment of FIG. 9, when the battery cell is charged and discharged, the temperature rapidly increases at the initial stage due to the generated heat, and after about 1100 seconds or more, it appears as converging to a constant temperature or the temperature drops slightly.

As shown Table 1 above, in the comparative example, the gap between the maximum temperature of the center battery cell and the minimum temperature of the edge battery cell is 10.2 degrees Celsius, and in the present embodiment, the gap between the maximum temperature of the center battery cell and the minimum temperature of the edge battery cell is 8.5 degrees Celsius. Thus, it can be confirmed that the temperature gap in the present embodiment is reduced by approximately 16% compared to the comparative example.

FIGS. 10 and 11 illustrate a battery module according to another embodiment of the present disclosure.

The battery module according to the present embodiment can further include a heat conductive resin member 320 located between the heat conductive pad 330 and one end part of the battery cell 110 in which the double-sided folded sealing part DSF is formed, as illustrated in FIG. 11. As illustrated in FIG. 10, the heat conductive resin member 320 can be formed by filling the heat conductive resin 320p in the recessed pattern 330DP of the heat conductive pad 330, and then pressing the heat conductive pad 330 and the battery cell stack 120. It is preferable to press the heat conductive pad 330 and the battery cell stack 120 before the heat conductive resin 320p is cured. In another alternate embodiment, the heat conductive resin 320p can be filled in the direction of gravity when the heat conductive pad 330 is turned inside out to fill the heat conductive resin 320p in the recessed pattern 330DP of the heat conductive pad 330.

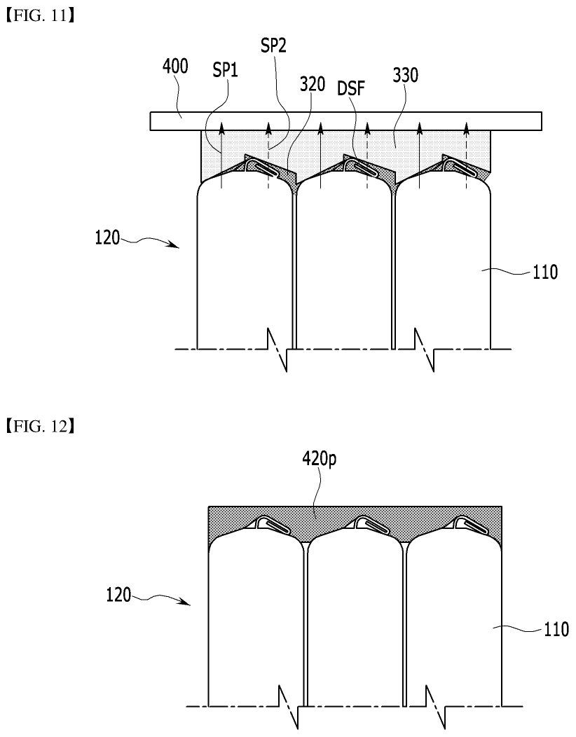

FIG. 12 is an illustration of a modified example of the method of filling the heat conductive resin of FIG. 10.

As illustrated in FIG. 12, a heat conductive resin 420p may be coated onto an end part of the battery cell stack 120, unlike the illustration in FIG. 10. Thereafter, the heat conductive pad 330 can be pressed on the battery cell stack 120 coated with the heat conductive resin 420p to form the heat conductive resin member 320, as illustrated in FIG. 11. According to the embodiments described in FIGS. 10 to 12, the air gap is further minimized by the heat conductive resin member 320, and therefore, it can be more advantageous in terms of heat efficiency than the case of supplementing the heat efficiency only by the heat conductive pad 330.

On the other hand, one or more of the battery modules according to the present embodiments can be packaged in a pack or case to form a battery pack.

The above-mentioned battery module and battery pack including the same can be applied to various devices. Such a device can be applied to a vehicle means such as an electric bicycle, an electric vehicle, or a hybrid vehicle, but the present disclosure is not limited thereto, and is applicable to various devices capable of using a battery module, which also falls under the scope of the present disclosure.

Although the invention has been shown and described above with reference to the preferred embodiments, the scope of the present disclosure is not limited thereto, and numerous other modifications and embodiments can be devised by those skilled in the art, which will fall within the spirit and scope of the principles of the invention described in the appended claims.

1. A battery module comprising:
a battery cell stack comprising a plurality of battery cells,
a housing for the battery cell stack, and
a heat conductive pad located between an upper part of the housing and the battery cell stack,
wherein the heat conductive pad comprises a recessed pattern on a surface of the heat conductive pad facing the battery cell stack, and wherein the recessed pattern corresponds to a first end part of the plurality of battery cells.

2. The battery module of claim 1, wherein:
the first end part of the plurality of battery cells has a double-sided folded shape.

3. The battery module of claim 2, wherein:
each of the plurality of battery cells comprises a cell case and an electrode assembly in the cell case, and
the double-sided folded shape of the first end part of the plurality of battery cells corresponds to a shape of a double-folded sealing part formed by folding a sealing part of the cell case at least twice.

4. The battery module of claim 3, further comprising an electrode lead that protruding from at least one of both side surfaces of the plurality of battery cells disposed along a direction perpendicular to the first end part of the plurality of battery cells,
wherein each of the plurality of battery cells has a rectangular shape with a longer side of the battery cell oriented in a direction in which the electrode lead protrudes.

5. The battery module of claim 3, wherein:
the recessed pattern of the heat conductive pad comprises a plurality of recessed parts, and
each of the plurality of recessed parts corresponds to the double-folded sealing part of each of the plurality of battery cells, respectively.

6. The battery module of claim 5, wherein:
the first end part of the battery cell has two inclined surfaces that are inclined at different angles, each of the plurality of recessed parts of the heat conductive pad independently corresponds to one of the two inclined surfaces, and the double-folded sealing part of each of the plurality of battery cells is in contact with each of the plurality of recessed parts, respectively.

7. The battery module of claim 6, wherein:
the double-folded sealing part comprises a plurality of inclined surfaces, and
the plurality of inclined surfaces of the double-folded sealing part and are in contact with a plurality of inclined surfaces of the heat conductive pad on which the plurality of recessed parts are formed.

8. The battery module of claim 1, wherein:
the heat conductive pad has a first surface facing the upper part of the housing, and a second surface facing the battery cell stack, and the first surface and the second surface are asymmetric with respect to each other.

9. The battery module of claim 8, wherein:
the first surface of the heat conductive pad has a surface parallel to the upper part of the housing.

10. The battery module of claim 1, wherein:
the recessed pattern has a sawtooth shape.

11. The battery module of claim 1,
further comprising a heat conductive resin layer located between the lower part of the housing and the battery cell stack.

12. The battery module of claim 11, wherein:
the housing comprises a frame including a bottom part and two side parts facing each other, and an upper plate covering an open upper part of the frame, and
the heat conductive resin layer is located between the bottom part of the frame and the battery cell stack.

13. The battery module of claim 12, wherein:
the bottom part and the side parts of the frame member are integrally formed.

14. The battery module of claim 1,
further comprising a heat conductive resin member located between the recessed pattern of the heat conductive pad and the first end part of the battery cell.

15. A battery pack comprising the battery module of claim 1.
